(19) United States
(12) Patent Application Publication
(10) Pub. No.: US 2008/0177531 A1
(43) Pub. Date: Jul. 24, 2008

(54) Language processing apparatus, language processing method, and computer program

(75) Inventor: Tetsuji Nakagawa, Osaka (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/007,378

(22) Filed: Jan. 9, 2008

(30) Foreign Application Priority Data
Jan. 19, 2007 (JP) JP2007-010871
May 22, 2007 (JP) JP2007-135691

(51) Int. Cl. G06F 17/27

(52) U.S. Cl. 704/9

(57) ABSTRACT

This invention provides a language processing apparatus analyzing a dependency structure of an input sentence, including: a segment unit model parameter estimating part estimating a segment unit model parameter as a parameter of a probability model to analyze the dependency structure by using a feature in a unit of segment; a sentence unit model parameter estimating part estimating a sentence unit model parameter as a parameter of a probability model to analyze the dependency structure by using a feature in a unit of sentence; a dynamic sample generating part generating a sample of the dependency structure of the input sentence from the probability model characterized by the sentence unit model parameter and the segment unit model parameter; and a dependency structure determining part determining a suitable dependency structure from the sample of the dependency structure of the input sentence generated by the dynamic sample generating part.

### CROSS REFERENCE TO RELATED APPLICATIONS

The disclosure of Japanese Patent Application No. JP 2007-010871 filed on Jan. 19, 2007 and No. JP 2007-135691 filed on May 22, 2007 are incorporated herein by reference in its entirety.

### BACKGROUND OF THE INVENTION

1. Field of the Invention

The present invention relates to a language processing apparatus, a language processing method that analyze language, and a computer program.

2. Description of the Related Art

In performing machine translation by a language processing apparatus such as machine translation system, the input sentence input by a user is subject to parsing, etc. and translation is performed based on the structure of the input sentence obtained by the parsing, etc., for example.

In the above language processing apparatus, it is often necessary to analyze a dependency structure of the input sentence. It should be noted that the dependency structure means the structure indicating the relation of modification/modificand (modification relation) between words or segments, for example.

As the method of analyzing the dependency structure, a method based on rule and a statistical method can be considered. The statistical method has an advantage that the parameter, etc. necessary for dependency structure analysis can be automatically estimated from learning data (for example, refer to Nonpatent Literature 1, “SAIDAI ENTROPY HOU NI MOTODUKU MODEL WO MOTIITA NIHONGO KAKARIUKE KAISEKI” by Kiyotaka Uchimoto, other 2, Journal of Information Processing Society of Japan, 1999, Vol. 40, No. 9, pp. 3397-3407). In the dependency structure analysis based on the statistical method, the dependency structure of unknown sentence is determined by the information (feature) to be a key included in the data. Therefore, the accuracy of dependency structure analysis changes according to the type of feature to be used.

In the Nonpatent Literature 1, the dependency structure of sentence is statistically calculated by calculating the probability of two segments having a modification relation by using maximum entropy model.

In the analyzing method of dependency structure disclosed in the Nonpatent Literature 1, however, it is assumed that each modification relation in sentence is independent to each other and the available feature is restricted. Accordingly, when this assumption does not hold, the analysis may fail.

In the Nonpatent Literature 2, “CHANKING NO DANKAITEKIYOU NI YORU NIHONGO KAKARIUKE KAISEKI”, by Taku Kudou, Yuji Matsumoto, Journal of Information Processing Society of Japan, 2002, Vol. 43, No. 6, pp. 1834-1841, the dependency structure in the whole sentence is determined by applying in phases the judgment whether the adjacent two segments are dependent to each other or not by using a support vector machine.

In the analyzing method of dependency structure disclosed in the Nonpatent Literature 2, it is not assumed that each modification relation in sentence is independent to each other. When it is judged whether certain two segments have a modification relation or not, there are also considered the features obtained by the segment depending on the focused source of segment, the segment depending on the focused destination of segment and the segment on which the focused destination of segment depends. By utilizing such features, the dependency structure of sentence can be determined with higher accuracy.

In the analyzing method of dependency structure disclosed in the Nonpatent Literature 2, however, a crucial analysis is sequentially performed.

In other words, the modification relation in sentence is judged one by one in order. Accordingly, although the feature obtained by the segment whose modification relation has already been judged can be used, the feature obtained by the segment whose modification relation has not been judged yet cannot be used.

In the analyzing method of dependency structure disclosed in the Nonpatent Literature 2, as described above, there can be used not only the feature in a unit of segment in the case of assuming that the destination of modification of each segment is independent to each other, but also a part of the feature in a unit of sentence such as each destination of modification in a plurality of segments included in the sentence. However, the available information is restricted and an arbitrary feature in a unit of sentence cannot be necessarily used.

In the Nonpatent Literature 3, “Discriminative Reranking for Natural Language Parsing”, by Collins and Koo, Computational Linguistics, 2004, Vol. 31, No. 1, to solve the problems as described above, the method based on reranking is applied. In this method, a conventional method is used first to obtain the top x solution candidates (for example, x=30) that are assumed to be correct.

Next with regard to the x candidates, the most suitable candidate is determined by using the feature in a unit of sentence. In this method, since all modification relations in the sentence have already been determined with regard to x candidates, an arbitrary feature in a unit of sentence can be used.

In the analyzing method of dependency structure disclosed in the Nonpatent Literature 3, however, when a correct answer is not included in the x solution candidates obtained first, the correct answer cannot be output in any way.

### SUMMARY OF THE INVENTION

To solve the aforementioned problems, according to a first aspect of the present invention, there is provided a language processing apparatus that analyzes a dependency structure of an input sentence. The language processing apparatus includes: a segment unit model parameter estimating part that estimates a segment unit model parameter as a parameter of a probability model to analyze the dependency structure by using a feature in a unit of segment; a sentence unit model parameter estimating part that estimates a sentence unit model parameter as a parameter of a probability model to analyze the dependency structure by using a feature in a unit of sentence; a sample generating part that generates a sample of the dependency structure of the input sentence from the probability model defined by the sentence unit model parameter and the segment unit model parameter; and a dependency structure determining part that determines a suitable dependency structure from the sample of the dependency structure of the input sentence generated by the sample generating part.

To solve the aforementioned problems, according to another aspect of the present invention, there is provided a language processing method that analyzes a dependency structure of an input sentence. The language processing method includes: a segment unit model parameter estimating step that estimates a segment unit model parameter as a parameter of a probability model to analyze the dependency structure by using a feature in a unit of segment; a sentence unit model parameter estimating step that estimates a sentence unit model parameter as a parameter of a probability model to analyze the dependency structure by using a feature in a unit of sentence; a dynamic sample generating step that generates a sample of the dependency structure of the input sentence from the probability model defined by the sentence unit model parameter and the segment unit model parameter; and a dependency structure determining step that determines a suitable dependency structure from the sample of the dependency structure of the input sentence generated by the dynamic sample generating step.

To solve the aforementioned problems, according to another aspect of the present invention, there is provided a computer program that makes a computer function as a language processing apparatus that analyzes a dependency structure of an input sentence. The computer program includes: a segment unit model parameter estimating module that estimates a segment unit model parameter as a parameter of a probability model to analyze the dependency structure by using a feature in a unit of segment; a sentence unit model parameter estimating module that estimates a sentence unit model parameter as a parameter of a probability model to analyze the dependency structure by using a feature in a unit of sentence; a sample generating module that generates a sample of the dependency structure of the input sentence from the probability model defined by the sentence unit model parameter and the segment unit model parameter; and a dependency structure determining module that determines a suitable dependency structure from the sample of the dependency structure of the input sentence generated by the sample generating module.

To solve the aforementioned problems, further, according to another aspect of the present invention, there is provided a language processing method wherein the sample of the dependency structure of the input sentence is generated from the probability model defined by the segment unit model parameter and the sentence unit model parameter and the suitable dependency structure is determined from the generated sample by using a maximum spanning tree searching method.

To solve the aforementioned problems, further, according to another aspect of the present invention, there is provided a language processing method wherein the label of the modification relation as well as a destination of modification of each word in the input sentence are simultaneously processed by a segment unit model and a sentence unit model by generating a sample of labeled dependency structure tree of the input sentence by using a segment unit model parameter with label information and a sentence unit model parameter with label information.

To solve the aforementioned problems, still further, according to another aspect of the present invention, there is provided a language processing method wherein the label of the modification relation and the destination of modification are simultaneously processed in the sentence unit model in the input sentence while the destination of modification and the label are separately processed in the segment unit model in the input sentence by generating the sample of the labeled dependency structure tree of the input sentence by using a segment unit model parameter without label information, the model parameter for labeling and the sentence unit model parameter with label information.

To solve the aforementioned problems, moreover, according to another aspect of the present invention, there is provided a language processing apparatus including: a dynamic sample generating part that generates the sample of the dependency structure of the input sentence from the probability model defined by the segment unit model parameter and the sentence unit model parameter; and a solution searching part that determines the suitable dependency structure from the generated sample by using a maximum spanning tree searching method.

To solve the aforementioned problems, further, according to another aspect of the present invention, there is provided a language processing apparatus including: a labeled dynamic sample generating part that processes the label of the modification relation as well as a destination of modification of each word in the input sentence simultaneously by a segment unit model and a sentence unit model by generating a sample of labeled dependency structure tree of the input sentence by using a segment unit model parameter with label information and a sentence unit model parameter with label information; and a solution searching part that determines the suitable dependency structure from the generated sample by using a maximum spanning tree searching method.

To solve the aforementioned problems, still further, according to another aspect of the present invention, there is provided a language processing apparatus including: a labeled dynamic sample generating part that processes the label of the modification relation and the destination of modification simultaneously in the sentence unit model in the input sentence and processes the destination of modification and the label separately in the segment unit model in the input sentence by generating the sample of the labeled dependency structure tree of the input sentence by using a segment unit model parameter without label information, the model parameter for labeling and the sentence unit model parameter with label information; and a solution searching part that determines the suitable dependency structure from the generated sample by using a maximum spanning tree searching method.

### BRIEF DESCRIPTION OF THE DRAWING(S)

FIG. 1 is a block diagram showing a schematic configuration of a language processing apparatus according to a first embodiment of the present invention;

FIG. 2 is a flowchart showing an outline of a processing from a dependency structure analysis of an input sentence to an output thereof according to the same embodiment;

FIG. 3 is a flowchart showing an outline of a processing from learning a parameter required in analyzing the dependency structure based on a learning data to storing thereof according to the same embodiment;

FIG. 4 is a configuration diagram schematically showing a language processing apparatus indicating a second embodiment of the present invention;

FIG. 5 is a flowchart showing a dependency structure analysis processing in FIG. 4;

FIG. 6 is a flowchart showing a parameter estimation processing in FIG. 4;

FIG. 7 is a configuration diagram schematically showing a language processing apparatus indicating a third embodiment of the present invention;

FIG. 8 is a flowchart showing a dependency structure analysis processing in FIG. 7;

FIG. 9 is a flowchart showing a parameter estimation processing in FIG. 7;

FIG. 10 is a configuration diagram schematically showing a language processing apparatus indicating a fourth embodiment of the present invention and

FIG. 11 is a flowchart showing a parameter estimation processing in FIG. 10.

### DETAILED DESCRIPTION OF THE PREFERRED EMBODIMENT(S)

Hereinafter, a preferred embodiment of the present invention will be described in detail with reference to the appended drawings. Note that, in this specification and the appended drawings, structural elements that have substantially the same function and structure are denoted with the same reference numerals, and repeated explanation of these structural elements is omitted.

### First Embodiment

(Language Processing Apparatus 101)

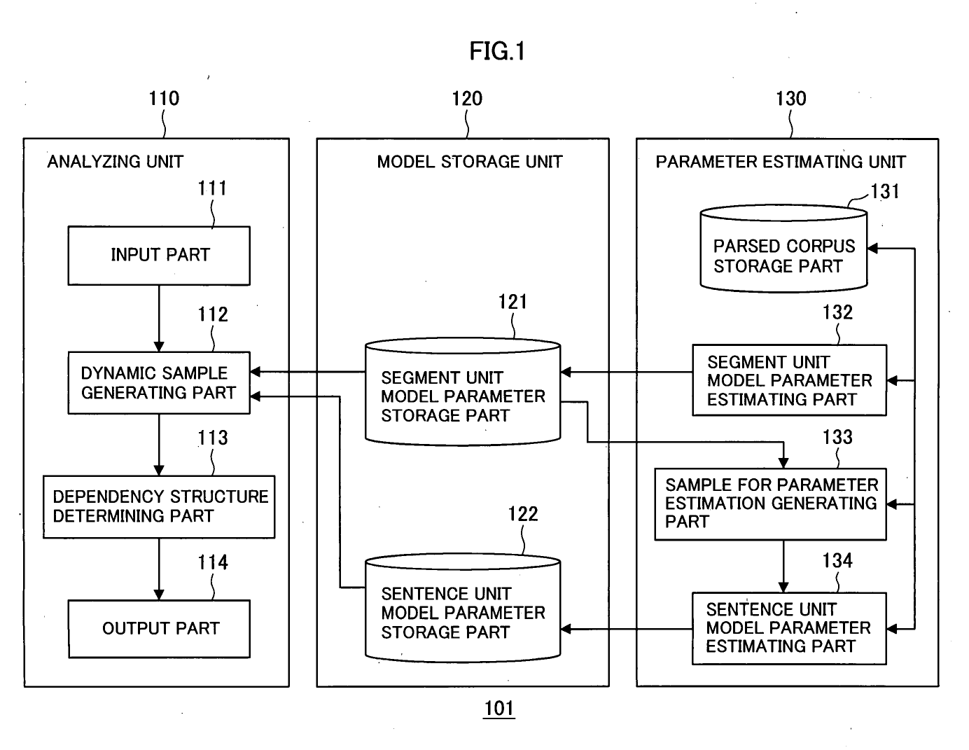

First, a language processing apparatus in this embodiment will be described in reference to FIG. 1. It should be noted that FIG. 1 is a block diagram showing a schematic configuration of the language processing apparatus according to this embodiment.

The language processing apparatus according to this embodiment can be shown in FIG. 1 in terms of function.

As shown in FIG. 1, the language processing apparatus 101 includes: an analyzing unit 110 that analyzes a dependency structure of an input sentence to determine a modification relation; a model storage unit 120 that stores a parameter of model used to analyze the dependency structure; and a parameter estimating unit 130 that learns the model parameter from a parsed corpus.

The analyzing unit 110 includes: an input part 111 to accept the input from a user by regarding the sentence whose dependency structure is analyzed as an input sentence; a dynamic sample generating part 112; a dependency structure determining part 113; and an output part 114 that outputs the sentence whose dependency structure has been determined to the user, etc., as shown in FIG. 1.

The dynamic sample generating part 112 uses the information stored in a segment unit model parameter storage part 121 and a sentence unit model parameter storage part 122 with regard to the input sentence accepted in the input part 111 to generate one or more samples from the probability distribution characterized (or defined, modeled) by these parameters.

The dependency structure determining part 113 determines the dependency structure of the input sentence by using the sample generated by the dynamic sample generating part 112.

The input part 111 according to this embodiment can be exemplified by, for example, input means such as keyboard and button capable of accepting the sentence whose dependency structure is analyzed from the user. However, when the sentence whose dependency structure is analyzed can be accepted from the user or program, the input part 111 is not restricted to such examples and, for example, a mouse, a stylus pen or a joystick is applicable.

The output part 114 according to this embodiment can be in any forms as long as the analysis result of the dependency structure can be output to those using the analysis result of the dependency structure (for example, user or program).

Also as shown in FIG. 1, the model storage unit 120 includes the segment unit model parameter storage part 121 and the sentence unit model parameter storage part 122.

The segment unit model parameter storage part 121 stores the parameter of the segment unit model to be used in the dynamic sample generating part 112 and a sample for parameter estimation generating part 133. It should be noted that the parameter of the segment unit model is the parameter dependent on the segment unit model to analyze the dependency structure by using the feature in a unit of segment and is calculated by a segment unit model parameter estimating part 132, which will be described later.

The sentence unit model parameter storage part 122 stores the parameter of the sentence unit model to be used in the dynamic sample generating part 112. It should be noted that the parameter of the sentence unit model is the parameter dependent on the sentence unit model to analyze the dependency structure by using the feature in a unit of sentence and is calculated by a sentence unit model parameter estimating part 134, which will be described later.

Also as shown in FIG. 1, the parameter estimating unit 130 includes: a parsed corpus storage part 131; the segment unit model parameter estimating part 132; the sample for parameter estimation generating part 133; and the sentence unit model parameter estimating part 134.

The parsed corpus storage part 131 stores the parsed corpus used in: the segment unit model parameter estimating part 132; the sample for parameter estimation generating part 133; and the sentence unit model parameter estimating part 134.

It should be noted that the parsed corpus is the parsed corpus for natural language processing and is built by a user or a computer.

The segment unit model parameter estimating part 132 calculates the segment unit model parameter by using the parsed corpus stored in the parsed corpus storage part 131 and sends the result to the segment unit model parameter storage part 121. The sent segment unit model parameter is stored in the segment unit model parameter storage part 121.

The sample for parameter estimation generating part 133 generates the sample of dependency structure for each sentence in the parsed corpus from the probability distribution defined by the parameter, by using the parsed corpus stored in the parsed corpus storage part 131 and the segment unit model parameter stored in the segment unit model parameter storage part 121.

Further, the sample for parameter estimation generating part 133 sends the generated sample to the sentence unit model parameter estimating part 134.

The sentence unit model parameter estimating part 134 calculates the sentence unit model parameter by using the parsed corpus stored in the parsed corpus storage part 131 and the sample generated by the sample for parameter estimation generating part 133.

Further, the sentence unit model parameter estimating part 134 sends the result of calculation (sentence unit model parameter) to the sentence unit model parameter storage part 122. The sentence unit model parameter storage part 122 stores the sent sentence unit model parameter.

(Analysis Processing of Dependency Structure)

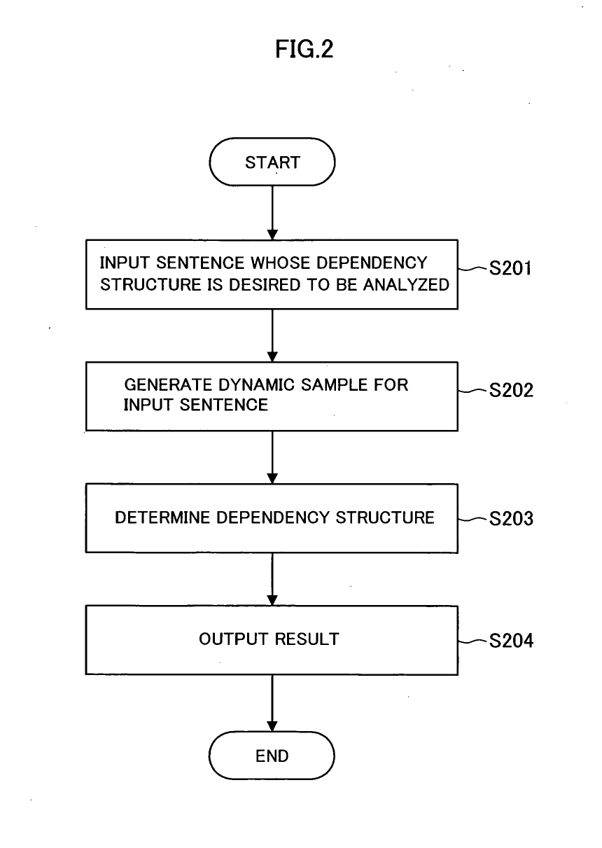

Next, an analysis processing of dependency structure according to this embodiment will be described in reference to FIG. 2, etc. FIG. 2 is a flowchart showing an outline of a processing of the language processing apparatus according to this embodiment from the dependency structure analysis of the input sentence accepted from a user to an output of the sentence.

First as shown in FIG. 2, the user inputs the sentence whose dependency structure is desired to be analyzed by using the input part 111 (step S201). Note that it is assumed that the sentence input by the input part 111 has already been divided into words or segments and the word class thereof is estimated.

Here, the t-th segment (or word and word class thereof, etc.) in the input sentence is indicated as wₜ. In addition, the whole input sentence is indicated as a set W of the segments in the input sentence and the number of segments included in the sentence is indicated as |W|.

In other words, the above description is indicated as the following expression 1.

W={w₁, . . . , w_{|W|}} Expression 1

In addition, it is indicated as hₜ what number of segment in the sentence the destination of modification of the t-th segment is, and the set of hₜ is indicated as H.

In other words, the above description is indicated as the following expression 2.

H={h₁, . . . , h_{|W|}} Expression 2

However, since the segment of the head-word of the whole sentence does not have the destination of modification, the destination of modification of such a word is indicated as, for example, 0.

Therefore, the dependency structure analysis as an object of the language processing apparatus according to this embodiment is the calculation of the set H of the destination of modification of each word when the word line W is input.

Next, the dynamic sample generating part 112 uses the segment unit model parameter stored in the segment unit model parameter storage part 121 and the sentence unit model parameter stored in the sentence unit model parameter storage part 122 to generate the sample dynamically by Gibbs Sampling for the word line W input in the input part 111 from the probability distribution of dependency structure defined by these parameters (segment unit model parameter and sentence unit model parameter) (step S202).

Hereinafter, the above-mentioned Gibbs Sampling (or, Gibbs Sampler, heat bath method) will be briefly described. Gibbs Sampling is the method of generating the sample dynamically by rewriting the value of variable sequentially by using random number.

It should be noted that the part with the value of variable rewritten is performed by sampling from a conditional distribution. A variable x is divided into several components to be indicated as x={xᵢ}, i=1, . . . , N, in which xᵢ may be an existing natural element or what is regrouped in several numbers.

One component xᵢ is selected every time to be newly picked up with the present value left. In picking up newly, the previous value with the same component is not referred to. At the time, the new value of xᵢ is selected by a conditional probability P (xᵢ|x₁, . . . , xᵢ₋₁, xᵢ₊₁, . . . , x_{N}) where other components are fixed. This is Gibbs Sampling, which is characterized in that the previous value with the same component is not referred to in picking up newly. In the case of metric variable, a conditional density will be considered.

In other words, starting from an arbitrary initial state, one component is newly picked up according to the conditional probability where other components are fixed. This operation is endlessly repeated. At this time, a component i may be selected randomly every time or selected in sequence in the predetermined order before starting a calculation.

Gibbs Sampling is the approach where the problem is divided, the divided ones are sectionalized into the ones that can be dealt with efficiently and the ones are aggregated. The point of Gibbs Sampling is that as the method of aggregating the state is partially updated according to the sampling from the conditional distribution. With this, a self-consistent calculation can be performed as a whole and at the same time the failure of calculation due to the gap between parts and whole can be prevented even in the case of high dimension.

It is assumed that a target distribution is a posteriori distribution π* and that the probability density function thereof is indicated as π(θ|x) where θ can be divided into several blocks as θ=(θ₁, . . . , θₚ). In addition, when x is given as θ₋ᵢ=(θ₁, . . . , θᵢ₋₁, θᵢ₊₁, . . . , θₚ) the probability density function of the conditional posteriori distribution π*ᵢ is indicated as π(θᵢ|θ₋ᵢ, x). And it is assumed that the sampling from the conditional distribution can be performed easily.

At this time, in the algorism of Gibbs Sampling:

(1) determine initial value θ (0)=(θ⁽⁰⁾₁, θ⁽⁰⁾₂, . . . , θ⁽⁰⁾ₚ) and set as t=1
(2) with regard to i=1, . . . , p
generate θ^{(t)}₁, ˜π(θᵢ, |θ^{(t)}₋ᵢ, x),
θ^{(t)}₋ᵢ, ˜π(θ^{(t)}ᵢ, . . . , θ^{(t)}ᵢ₋₁, θ^{(t-1)}ᵢ₊₁, . . . , θ^{(t-1)}ₚ),
   (3) set t as t+1 and return to (2).
   The above (2) and (3) are repeated and θ^{(t)}=(θ^{(t)}₁, θ^{(t)}₂, . . . , θ^{(t)}ₚ) is set as a probability sample of the posteriori distribution π* in the case of t≧N with regard to sufficiently large number N.

Here, the description about Gibbs Sampling according to this embodiment will be ended. In addition, Gibbs Sampling performed by the dynamic sample generating part 112 is the same as Gibbs Sampling described in reference literature 1 (Yukihito Iba, other 5, “KEISAN TOUKEI II—Markov Chain Monte Carlo HOU TO SONO SYUUHEN-”, Iwanami Shoten, Publishers. 2005).

Here, the probability distribution of the sentence unit dependency structure, i.e., the probability distribution of H in the case of giving W is defined as the following expression 3.

$$P ( H \vert W ) = \frac{1}{Z ( W )} Q ( H \vert W ) exp \{ {\sum }_{k = 1}^{K} {λ}_{k} {F}_{k} ( W , H ) \} . \qquad Expression 3$$

However, Z(W) in the expression 3 is defined as the following expression 4.

$$Z ( W ) = {\sum }_{{H}^{′} ∈ Ω ( W )}^{ } Q ( {H}^{′} \vert W ) exp \{ {\sum }_{k = 1}^{K} {λ}_{k} {F}_{k} ( W , {H}^{′} ) \} . \qquad Expression 4$$

In the above expression 3 or 4, Q(H|W) indicates the probability distribution of the dependency structure calculated by using the feature in a unit of segment while {λₖ} indicates the sentence unit model parameter. In addition, Ω(W) indicates the set configured by a possible arbitrary H in the case of giving the segment set W while Fₖ(W, H) is the feature in a unit of sentence.

As the above Fₖ(W, H), for example, with regard to each segment wₜ in the sentence, the destination w_{h′}(h′=hₜ) of modification of the segment and the destination w_{h′}(h′=hₜ) of modification of the sentence can be used.

In addition, with regard to each segment wₜ in the sentence, the combination of all segments {w_{t′}|h_{t′}=t} dependent on the segment and the segment wₜ can be used as well. Further, since the sentence is the set of segments, the feature in a unit of segment may be included in a part of the feature in a unit of sentence.

Here, the probability distribution Q(H|W) of the dependency structure calculated by using the feature in a unit of segment is defined as the following expressions 5-7.

$$\begin{matrix}Q ( H \vert W ) = {\prod }_{t = 1}^{\vert W \vert} q ( {h}_{t} \vert W , t ) . & Expression 5 \\ q ( h \vert W , t ) = \frac{1}{Y ( W , t )} exp \{ {\sum }_{l = 1}^{L} {μ}_{l} {g}_{l} ( W , t , h ) \} . & Expression 6 \\ Y ( W , t ) = {\sum }_{h = 0}^{\vert W \vert} exp \{ {\sum }_{l = 1}^{L} {μ}_{l} {g}_{l} ( W , t , h ) \} & Expression 7\end{matrix}$$

In the expressions 5-7, μ₁ is the segment unit model parameter. In addition, g₁(W, t, h) is the feature in a unit of segment about the fact that the t-th segment in a segment line W is dependent on the h-th segment.

As the above g₁(W, t, h), for example, as each header of wₜ and wₕ, word class, distance between segments or presence/absence of pause mark between segments, the feature and so on can be used as described in nonpatent literature 1 (Kiyotaka Uchimoto, other 2, “SAIDAI ENTROPY HOU NI MOTODUKU MODEL WO MOTIITA NIHONGO KAKARIUKE KAISEKI”, Journal of Information Processing Society of Japan, 1999, Vol. 40, No. 9, pp. 3397-3407).

In the nonpatent literature 1, there is described as follows. Feature is, for example, the information to calculate the probability of the modification between two segments. More specifically, feature includes surface string, word class, inflected forms, presence/absence of parentheses and punctuation, distance between segments or the combination thereof, etc. as described in table 2 (refer to page 3401 in the nonpatent literature 1). The feature in the table 2 is configured by feature name and feature value and indicates an attribution that can be held by each segment (preceding segment and after segment) or an attribution that can appear in between two segments in the case of focusing two segments in one sentence.

As described above, the probability distribution of the dependency structure calculated by using the feature in a unit of segment is calculated by assuming the independency among the modification relations in the sentence.

In the case of generating a sample from the probability distribution P(H|W) defined as such, the sample cannot be easily generated since H is a high-dimensional probability variable.

In this embodiment, therefore, Gibbs Sampling is used to generate the sample dynamically. There is described about Gibbs Sampling in, for example, the reference literature 1, etc., as described above.

Here, it is assumed that S (for example, S=100) samples {H⁽¹⁾, . . . , H^{(S)}} are generated. It should be noted that in a normal context-sensitive grammar the destination of modification of the segment does not become the segment itself. Accordingly, there may be calculated by defining that the probability of the segment itself becoming the destination of modification is 0.

In Japanese, in addition, it is known that the destination of modification of a certain segment always exists behind the segment, that the segment at the end of a sentence becomes the head-word of the whole sentence and that the segment at the next-to-last of the sentence certainly depends on the segment at the end of the sentence.

In analyzing such a language, there may be calculated in accordance with constraints where the probability of depending on a previous word is 0, where the probability of the last word becoming a head-word of the whole sentence is 1 and where the probability of a next-to-last word depending on the last word is 1. Further, the sample of an unneeded candidate can be prevented from being generated to perform sampling efficiently. For example, if the example where the segment of word class A depends on the segment of word class B does not exist in the parsed corpus storage part 131, such a modification relation may be out of consideration in generating the sample. In addition, the modification relation with sufficiently low probability (for example, lower than 0.5%) calculated by using the feature in a unit of segment may be out of consideration as well.

Next as shown in FIG. 2, the dependency structure determining part 113 determines the dependency structure (or solution) that seems to be a suitable dependency structure of the input sentence by using the samples {H⁽¹⁾, . . . , H^{(S)}} generated by the dynamic sample generating part 112 (step S203).

There will be described the processing (step S203) by the dependency structure determining part 113. Here, as follows, the dependency structure determining part 113 determines a destination (hₜ) of modification of t-th word calculated by the following expression 8, by maximizing a marginal probability approximately calculated. However, the present invention is not restricted to such an example. The expressions (expressions 8-10) to determine the destination of modification of the t-th word will be shown below.

$$\begin{matrix}{\hat{h}}_{t} = {arg max }_{h} {P}_{t} ( h \vert W ) . & Expression 8 \\ {P}_{t} ( h \vert W ) = {\sum }_{{h}_{1} , … , {h}_{t - 1} , {h}_{t + 1} , … , {h}_{\vert W \vert}}^{ } P ( H \vert W ) , & Expression 9 \\ ≅ \frac{1}{S} {\sum }_{s = 1}^{S} δ ( h , {h}_{t}^{( S )} ) . & Expression 10\end{matrix}$$

Next as shown in FIG. 2, the output part 114 outputs the dependency structure of the input sentence determined by the dependency structure determining part 113, to the user (step S204).

There will be ended the description about the processing from analyzing the dependency structure of the input sentence accepted from the user as shown in FIG. 2 to outputting the sentence.

(Parameter Estimation Processing)

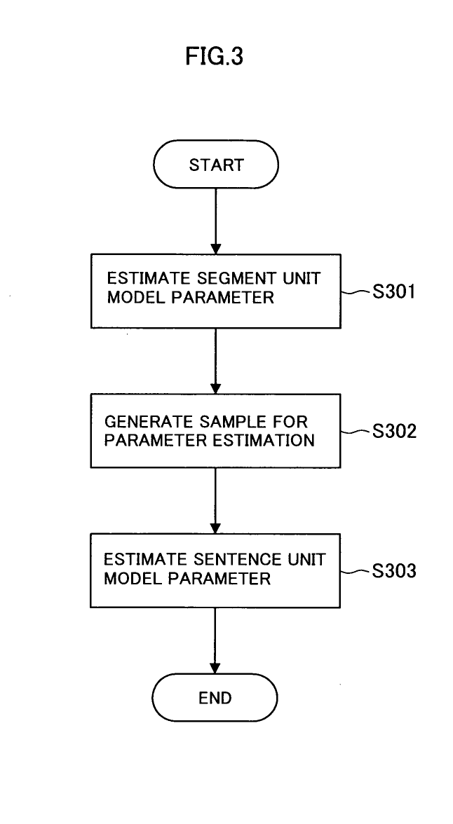

Next, there will be described the processing from learning a necessary parameter from a learning data according to this embodiment to storing in reference to FIG. 3. FIG. 3 is a flowchart showing an outline of a processing from learning a parameter required in analyzing the dependency structure based on a learning data to storing thereof on the side of the language processing apparatus according to the embodiment.

First as shown in FIG. 3, the segment unit model parameter estimating part 132 calculates the segment unit model parameter, i.e., {μ₁} in the expression 6 by using the parsed corpus stored in the parsed corpus storage part 131, and sends to the segment unit model parameter storage part 121 (step S301).

The segment unit model parameter storage part 121 stores the segment unit model parameter {μ₁} sent from the segment unit model parameter estimating part 132.

Here, the n-th sentence in the parsed corpus is indicated as Wⁿ and the dependency structure of the sentence as Hⁿ and it is assumed that there are N sentences in the parsed corpus.

In step S301, the parameter {μ₁} can be calculated from the parsed corpus {W¹, H¹, . . . , W^{N}, H^{N}} by using the method described in the nonpatent literature 1, etc. or quasi Newton method described later.

Next, the sample for parameter estimation generating part 133 generates the sample for parameter estimation for each sentence in the parsed corpus from the probability distribution Q(H|W) calculated by using the feature in a unit of segment defined by the parameters, by using the parsed corpus stored in the parsed corpus storage part 131 and the segment unit model parameter stored in the segment unit model parameter storage part 121. Then there is sent to the sentence unit model parameter estimating part 134 (step S302).

The sample for parameter estimation as described above can be calculated by using the expression 6 and a random number. Here, it is assumed that R (for example, R=100) samples {Hⁿ⁽¹⁾, . . . , H^{n(R)}} for parameter estimation are generated for each sentence Wⁿ in the corpus.

Finally, the sentence unit model parameter estimating part 134 uses the parsed corpus stored in the parsed corpus storage part 131 and the sample for parameter estimation generated by the sample for parameter estimation generating part 133 to calculate the sentence unit model parameter {λₖ} shown in the expressions 3 and 4, and sends to the sentence unit model parameter storage part 122 (step S303).

The sentence unit model parameter storage part 122 stores the sentence unit model parameter {λₖ} sent from the sentence unit model parameter estimating part 134.

Here, there will be described the method of calculating the sentence unit model parameter {λₖ} by using the samples {H¹⁽¹⁾, . . . , H^{1(R)}, . . . , H^{N(1)}, . . . , H^{N(R)}} generated from the parsed corpus {W¹, H¹, . . . , W^{N}, H^{N}} and the probability distribution Q(H|W) of the dependency structure in a unit of segment.

Here, the {λₖ} maximizing the value in an objective function shown in the following expressions 11-13 will be calculated.

$$\begin{matrix}L = log {\prod }_{n = 1}^{N} P ( {H}^{n} \vert {W}^{n} ) - \frac{1}{2 {σ}^{2} } {\sum }_{k = 1}^{K} {λ}_{k}^{2} , & Expression 11 \\ = {\sum }_{n = 1}^{N} [ \begin{matrix}- log Z ( {W}^{n} ) + \\ log Q ( {H}^{n} \vert {W}^{n} ) + \\ {\sum }_{k = 1}^{K} {λ}_{k} {F}_{k} ( {W}^{n} , {H}^{n} )\end{matrix} ] - \frac{1}{2 {σ}^{2}} {\sum }_{k = 1}^{K} {λ}_{k}^{2} , & Expression 12 \\ = {\sum }_{n = 1}^{N} [ \begin{matrix}- log Z ( {W}^{n} ) + \\ {\sum }_{k = 1}^{K} {λ}_{k} {F}_{k} ( {W}^{n} , {H}^{n} )\end{matrix} ] - \frac{1}{2 {σ}^{2}} {\sum }_{k = 1}^{K} {λ}_{k}^{2} + C . & Expression 13\end{matrix}$$

In the expressions 11-13, C is a constant and can be ignored. Also, σ is the constant set by, for example, a user, etc. (for example, σ=0.1, etc.). Differentiating the above expressions 11-13 partially, the following expressions 14 and 15 can be obtained.

$$\begin{matrix}\frac{\partial L}{\partial {λ}_{k}} = {\sum }_{n = 1}^{N} [ - \frac{\partial }{\partial {λ}_{k}} log Z ( {W}^{n} ) + {F}_{k} ( {W}^{n} , {H}^{n} ) ] - \frac{1}{{σ}^{2}} {λ}_{k} , & Expression 14 \\ = {\sum }_{n = 1}^{N} [ \begin{matrix}- {\sum }_{{H}^{′} ∈ Ω ( {W}^{n} )}^{ } P ( {H}^{′} \vert {W}^{n} ) {F}_{k} ( {W}^{n} , {H}^{′} ) + \\ {F}_{k} ( {W}^{n} , {H}^{n} )\end{matrix} ] - \frac{1}{{σ}^{2}} {λ}_{k} . & Expression 15\end{matrix}$$

Calculating the objective function as in the expression 13 and the partial differentiation of the expression 13 as in the expression 15, each value of λₖ can be calculated by using quasi Newton method, etc. With regard to the method of calculating each value of λₖ by using the above quasi Newton method, there is described in, for example, a reference literature 2 (Malouf: “A comparison of algorithms for maximum entropy parameter estimation”, Proceedings of CoNLL-2002, pp. 49-55).

In this embodiment, in the case of, for example, calculating each value of λₖ by using quasi Newton method, etc., there will be approximately calculated as follows. The reason for this is that the above expressions 13 and 15 include the term with the counting of any probable candidates required and that it is difficult to calculate in a practical time due to significantly large calculation amount.

Consequently, each term can be approximately calculated as shown in the following expressions 16-19.

$$\begin{matrix}log Z ( {W}^{n} ) = log {\sum }_{{H}^{′} ∈ Ω ( {W}^{n} )}^{ } Q ( {H}^{′} \vert {W}^{n} ) exp \{ {\sum }_{k = 1}^{K} {λ}_{k} {F}_{k} ( {W}^{n} , {H}^{′} ) \} , & Expression 16 \\ ≅ log \frac{1}{R} {\sum }_{r = 1}^{R} exp \{ {\sum }_{k = 1}^{K} {λ}_{k} {F}_{k} ( {W}^{n} , {H}^{n ( r )} ) \} . & Expression 17 \\ {\sum }_{{H}^{′} ∈ Ω ( {W}^{n} )}^{ } P ( {H}^{′} \vert {W}^{n} ) {F}_{k} ( {W}^{n} , {H}^{′} ) = {\sum }_{{H}^{′} ∈ Ω ( {W}^{n} )}^{ } Q ( {H}^{′} \vert {W}^{n} ) \frac{1}{Z ( {W}^{n} )} exp \{ {\sum }_{{k}^{′} = 1}^{K} {λ}_{{k}^{′}} {F}_{{k}^{′}} ( {W}^{n} , {H}^{′} ) \} {F}_{k} ( {W}^{n} \vert {H}^{′} ) , & Expression 18 \\ ≅ \frac{1}{R} {\sum }_{r = 1}^{R} \frac{1}{Z ( {W}^{n} )} exp \{ {\sum }_{{k}^{′} = 1}^{K} {λ}_{{k}^{′}} {F}_{{k}^{′}} ( {W}^{n} , {H}^{n ( r )} ) \} {F}_{k} ( {W}^{n} , {H}^{n ( r )} ) . & Expression 19\end{matrix}$$

As shown in the expressions 16-19, it becomes possible to reduce the calculation amount by approximating each term and each value of λₖ can be rapidly and efficiently calculated.

According to the language processing apparatus 101 in this embodiment, the dependency structure can be analyzed with high accuracy by using not only the feature in a unit of segment where it is assumed that the modification relation of each segment in a sentence is independent, but also the feature in a unit of sentence where any modification relations in a sentence are considered.

Also according to the language processing apparatus 101, since the model parameter is statistically estimated from learning data, the parameter suitable for the target data can be obtained.

In addition, a series of processings described above can be performed by dedicated hardware or software. In performing a series of processings by software, the program configuring the software is installed in an information processing device such as general-purpose computer and microcomputer, and the information processing device is functioned as the language processing apparatus 101.

The program may be recorded on a hard disk or ROM as a recording medium in a computer.

Or, the program can be temporarily or permanently stored in (recorded on) not only a hard disk drive but also a removable recording medium such as flexible disk, CD-ROM (Compact Disc Read Only Memory), MO (Magneto Optical) disk, DVD (Digital Versatile Disc), magnetic disk and semiconductor memory. Such a removable recording medium can be provided as so-called packaged software.

In addition, the program can be installed in a computer from the above-mentioned removable recording medium and further wirelessly transferred to a computer from a download site through satellite for Digital Satellite Broadcasting. Moreover, the program can be transferred by wired connections to a computer through the network such as LAN (Local Area Network) and the Internet. At this time, the computer can receive the program thus transferred to install in a built-in hard disk, etc.

Here, in this specification, the processing step to describe the program to have various processings performed as the language processing apparatus 101 is not necessarily required to be subject to a time-series processing according to the order described as a flowchart and includes the processing performed in parallel or individually.

Also, the program can be processed by one computer or by a plurality of computers to perform distributed processing.

### Second Embodiment

In the first embodiment, as the method of analyzing the dependent feature, the dependency structure of sentence is statistically analyzed by using an arbitrary feature in the sentence by using Gibbs Sampling.

In the first embodiment, in other words, there is provided a language processing method that analyzes a dependency structure of an input sentence, including: a segment unit model parameter estimating step that estimates a segment unit model parameter as a parameter of a probability model to analyze the dependency structure by using a feature in a unit of segment; a sentence unit model parameter estimating step that estimates a sentence unit model parameter as a parameter of a probability model to analyze the dependency structure by using a feature in a unit of sentence; a sample generating step that generates a sample of the dependency structure of the input sentence from the probability model defined by the sentence unit model parameter and the segment unit model parameter; and a dependency structure determining step that determines a suitable dependency structure from the sample of the dependency structure of the input sentence generated by the sample generating step.

In the method according to the first embodiment, as the method of selecting the solution of dependency structure (destination of modification of each word in a sentence), the destination of modification maximizing a marginal probability calculated by Gibbs Sampling is selected. A dependency structure tree does not include a cycle (node line going in a graph in cycles) and the modification relations do not intersect with each other according to the language in the dependency structure tree. However, the solution determined by the method according to the first embodiment does not always have a correct form as the dependency structure tree. In the method that has been proposed above, in addition, only the determination of the destination of modification of each word in the sentence is performed. In the application of natural language processing, however, the relation of modification (whether it is a subject or an object, whether it is a parallel structure, or other relations) as well as the fact which word each word in a sentence depends on, are often required.

In the language processing method and the apparatus therefor according to the second embodiment, consequently, only the solution of the correct form as the dependency structure tree is output and further the identification of the label of modification relation as well as the determination of the destination of modification are performed by applying a searching method of Maximum Spanning Tree. As such, using an arbitrary feature in a unit of sentence makes it possible to analyze the dependency structure without preparing a solution candidate in advance.

The language processing apparatus includes: a dynamic sample generating part that generates the sample of the dependency structure of the input sentence from the probability model defined by the segment unit model parameter and the sentence unit model parameter; and a solution searching part that determines the suitable dependency structure from the generated sample by using a maximum spanning tree searching method.

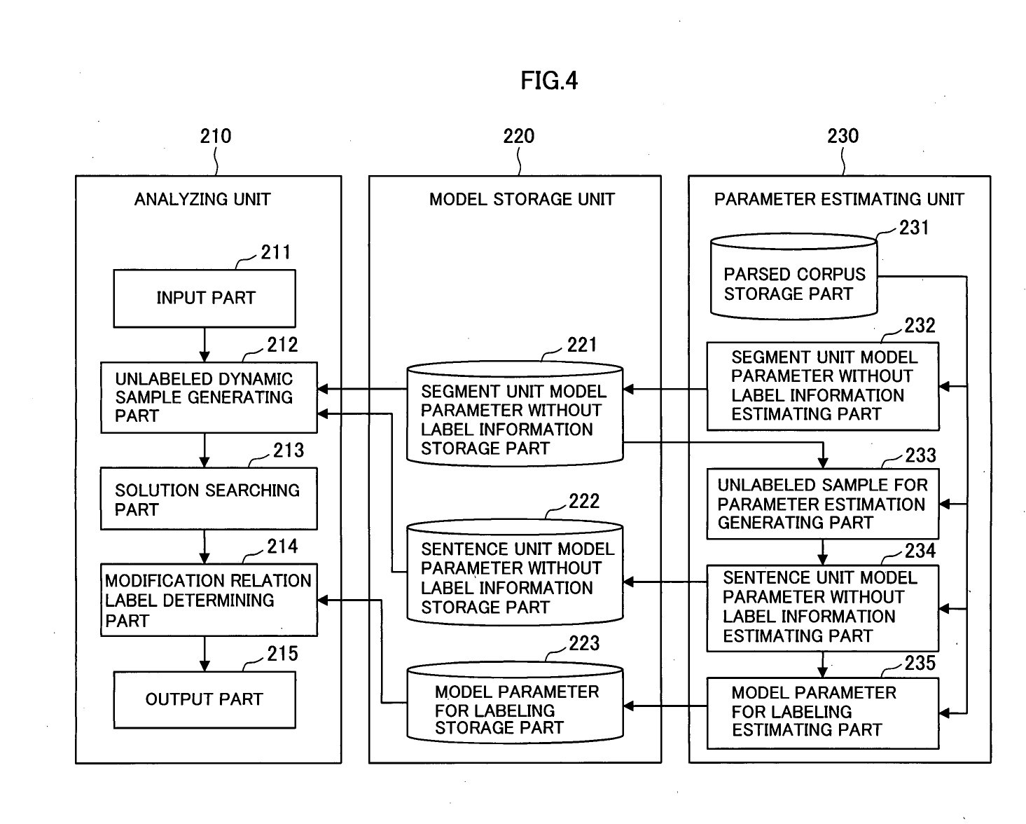

FIG. 4 is a configuration diagram schematically showing the language processing apparatus indicating the second embodiment of the present invention. This language processing apparatus is configured by, for example, performing a language analysis program by a computer including a central processing unit (hereafter, referred to as CPU), an external storage device, an internal storage device and so on. The language processing apparatus is also configured by: an analyzing unit 210 that analyzes a dependency structure of an input sentence to determine a modification relation; a model storage unit 220 that stores a parameter of probability model used to analyze the dependency structure; and a parameter estimating unit 230 that learns the model parameter from a parsed corpus.

The analyzing unit 210 includes: an input part 211 such as keyboard to accept the input of the sentence whose dependency structure is analyzed from a user; an unlabeled dynamic sample generating part 212; a solution searching part 213; a modification relation label determining part 214; and an output part 215 such as display and printer. These unlabeled dynamic sample generating part 212, solution searching part 213 and modification relation label determining part 214 are realized by, for example, a program control of CPU.

Among these, the unlabeled dynamic sample generating part 212 is connected to the input part 211 and uses the information on a segment unit model parameter without label information and a sentence unit model parameter without label information with regard to the input sentence to generate many samples of an unlabeled dependency structure analysis tree from the probability distribution defined by these model parameters. The solution searching part 213 is connected to the output side thereof. The solution searching part 213 determines the dependency structure of the input sentence by using the generated sample and the modification relation label determining part 214 is connected to the output side thereof. The modification relation label determining part 214 provides the label of dependency relation for the sentence whose dependency structure has been determined, by using the information on a model parameter for labeling and the output part 215 is connected to the output side thereof. The output part 215 is a device to output the sentence whose dependency structure and modification relation have been determined to the user.

The model storage unit 220 includes a first storage part (for example, a segment unit model parameter without label information storage part) 221, a second storage part (for example, a sentence unit model parameter without label information storage part) 222 and a third storage part (for example, a model parameter for labeling storage part) 223, which are configured by an external or internal storage device. Among these, the segment unit model parameter without label information storage part 221 stores the parameter of the segment unit model without label information to be used in the unlabeled dynamic sample generating part 212 and so on. The sentence unit model parameter without label information storage part 222 stores the parameter of the sentence unit model without label information to be used in the unlabeled dynamic sample generating part 212. Further, the model parameter for labeling storage part 223 stores the parameter of model for labeling to be used in the modification relation label determining part 214.

The parameter estimating unit 230 includes: a parsed corpus storage part 231; a segment unit model parameter without label information estimating part 232; an unlabeled sample for parameter estimation generating part 233; a sentence unit model parameter without label information estimating part 234; and a model parameter for labeling estimating part 235, which are connected to each other. Among these, the parsed corpus storage part 231 stores the parsed corpus used in other parameter estimating parts 232, 234, 235 and the sample generating part 233 and is configured by an external or internal storage device.

Other parameter estimating parts 232, 234, 235 and the sample generating part 233 are realized by, for example, a program control of CPU. Among these, the segment unit model parameter without label information estimating part 232 calculates the segment unit model parameter without label information by using the corpus stored in the parsed corpus storage part 231 and stores the result in the segment unit model parameter without label information storage part 221. The unlabeled sample for parameter estimation generating part 233 generates the unlabeled sample of dependency structure for each sentence in the corpus from the probability distribution defined by the parameter, by using the corpus stored in the parsed corpus storage part 231 and the segment unit model parameter without label information stored in the segment unit model parameter without label information storage part 221. Then the unlabeled sample for parameter estimation generating part 233 sends the generated sample to the sentence unit model parameter without label information estimating part 234.

The sentence unit model parameter without label information estimating part 234 calculates the sentence unit model parameter without label information by using the corpus stored in the parsed corpus storage part 231 and the sample generated by the unlabeled sample for parameter estimation generating part 233. Then the sentence unit model parameter without label information estimating part 234 stores the result in the sentence unit model parameter without label information storage part 222. Further, the model parameter for labeling estimating part 235 calculates the parameter of model for labeling by using the corpus stored in the parsed corpus storage part 231 and stores the result in the model parameter for labeling storage part 223.

(Analysis Processing of Dependency Structure in Language Processing Method According to the Second Embodiment)

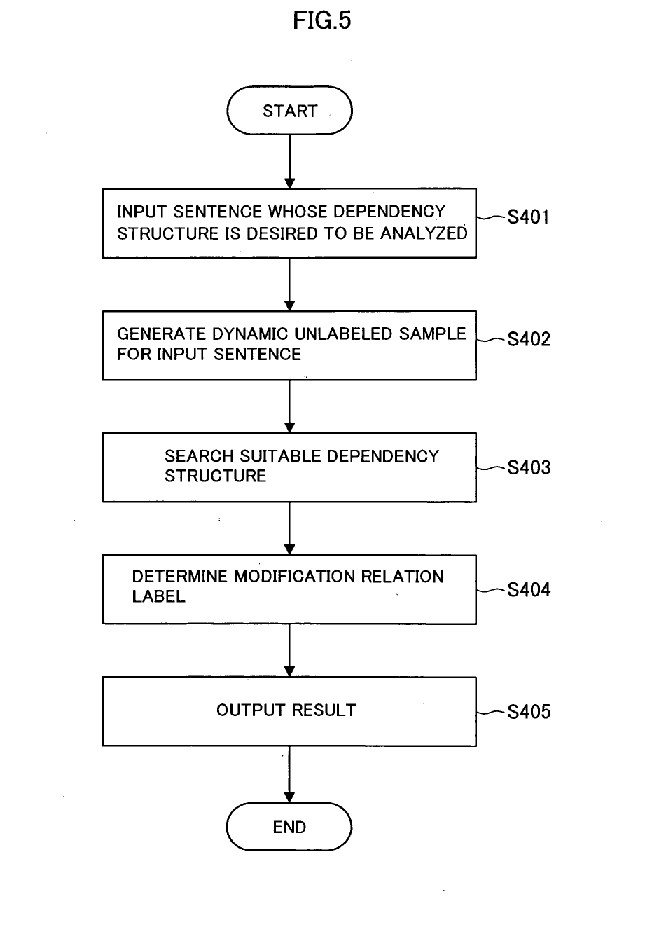

FIG. 5 is a flowchart showing a dependency structure analysis processing where the language processing apparatus shown in FIG. 4 analyzes the dependency structure of the sentence input by a user until the processing of the processing of outputting the sentence.

First, the user inputs the sentence whose dependency structure is desired to be analyzed by using the input part 211 (step S401). Note that it is assumed that the sentence to be input has already been divided into words or segments and the word class thereof has been estimated. Here, the t-th segment (word) in the input sentence is indicated as wₜ. In addition, the whole input sentence is indicated as a set W of the segments in the input sentence and the number of segments included in the sentence is indicated as |W|, as shown in the following expression 20.

W={w₁, . . . , w_{|W|}} Expression 20

In addition, it is indicated as hₜ what number of segment in the sentence the destination of modification of the t-th segment is, and the set of hₜ is indicated as H, as shown in the following expression 21.

H={h₁, . . . , h_{|W|}} Expression 21

However, since the segment of the head-word of the whole sentence does not have the destination of modification, the destination of modification of such a segment is indicated as, for example, 0. The label of modification relation of the t-th segment (whether it is a subject, or the like) is indicated as lₜ and the set of lₜ is indicated as L, as shown in the following expression 22.

L={l₁, . . . , l_{|W|}} Expression 22

Therefore, the dependency structure analysis as an object of the language processing method according to this embodiment is the calculations of the set H of the destination of modification of each segment and the set L of the label when the segment line W is input.

Next, the unlabeled dynamic sample generating part 212 uses the segment unit model parameter without label information stored in the segment unit model parameter without label information storage part 221 and the sentence unit model parameter without label information stored in the sentence unit model parameter without label information storage part 222 to generate the sample of the unlabeled dependency structure tree dynamically by Gibbs Sampling for the segment line W input by the input part 211 from the probability distribution of dependency structure in a unit of sentence defined by these parameters (step S402).

It should be noted that Gibbs Sampling performed by the unlabeled dynamic sample generating part 212 is the same as Gibbs Sampling described in the reference literature 1 as described above.

Therefore, the sample can be generated by using Gibbs Sampling with the method shown in the first embodiment, with regard to the probability distribution P(H|W).

Next, the solution searching part 213 searches and determines the solution that seems to be a suitable dependency structure by using the S samples {H⁽¹⁾, . . . , H^{(S)}} generated by the unlabeled dynamic sample generating part 212 (step S403). Here, the marginal probability defined as the following expressions 23, 24 will be used.

$$\begin{matrix}{P}_{t} ( h \vert W ) = {\sum }_{{h}_{1} , … , {h}_{t - 1} , {h}_{t + 1} , … , {h}_{\vert W \vert} {h}_{t} = h}^{ } P ( H \vert W ) , & Expression 23 \\ ≅ \frac{1}{S} {\sum }_{s = 1}^{S} δ ( h , {h}_{t}^{( s )} ) . & Expression 24\end{matrix}$$

Here, Pₜ(h|W) indicates the probability of h being the destination of modification of the t-th word. When the candidate maximizing the value simply is selected as the solution, the structure obtained as the result possibly has an inappropriate structure as the dependency structure tree such as including the cycle. Consequently, a suitable dependency structure tree will be searched by using a maximum spanning tree searching method. The dependency structure analysis can be solved as a search problem of maximum spanning tree as described in, for example, a reference literature 3 (University of Pennsylvania Department of Computer and Information Science Technical Report No. MS-CIS-06-11 (2006) McDonald et al. “Spanning Tree Methods for Discriminative Training of Dependency Parsers”).

As described in this reference literature 3, especially in the case of the language without the intersection of modification relation, the suitable maximum spanning tree can be calculated by using Eisner method while in the case of the language with the intersection of modification relation the suitable maximum spanning tree can be calculated by using Chu-Liu-Edmonds method. With regard to the algorithm for calculating these maximum spanning trees, the spanning tree to maximize the sum of a score s(i, j) of the edge from a node i toward a node j in the graph can be obtained from the graph. Then the word of the destination of modification is indicated as i and the word of the source of modification is indicated as j, to define the score s(i, j) as the following expression 25 by using the marginal probability.

s(i,j)=log Pⱼ(i|W). Expression 25

Using the score thus calculated along with Eisner method and Chu-Liu-Edmonds method makes it possible for the solution searching part 213 to search the suitable dependency structure.

The modification relation label determining part 214 determines the label of modification relation of each word by regarding the dependency structure determined by the solution searching part 213 as the input (step S404). Since the determination of the label of modification relation can be solved as a multivalued classification problem, the method for solving a multivalued classification problem can be applied. For example, the label can be determined by using the word form and word class of the word to be labeled, the peripheral word and the word of the destination of modification thereof as the feature by using maximum entropy or the support vector machine described in a reference literature 4 (Kin Akira, et al. “TOUKEIKAGAKU NO FRONTIER 10 GENGO TO SHINRI NO TOUKEI (2003)”).

For example, the model for labeling indicated by the probability distribution as in the following expressions 26-28 can be defined and the label L to maximize the probability can be calculated, by using maximum entropy model.

$$\begin{matrix}P ( L \vert W H ) = {\prod }_{t = 1}^{\vert W \vert} p ( {l}_{t} \vert W , H , t ) , & Expression 26 \\ p ( l \vert W , H , t ) = \frac{1}{X ( W , H , t )} exp \{ {\sum }_{j = 1}^{J} {v}_{j} {e}_{j} ( W , H , t , l ) \} , & Expression 27 \\ X ( W , H , t ) = {\sum }_{l}^{ } exp \{ {\sum }_{j = 1}^{J} {v}_{j} {e}_{j} ( W , H , t , l ) \} . & Expression 28\end{matrix}$$

In these expressions 26-28, νᵢ indicates the parameter of the model for labeling and eⱼ(W, H, t, l) indicates the feature where the t-th segment of the segment line W with H as the destination of modification has the label of modification relation as l. The output part 215 outputs the result of dependency structure analysis where the dependency structure and the modification relation for the input sentence have been identified output by the modification relation label determining part 214 to the user (step S405) to end the dependency structure analysis processing.

(Parameter Estimation Processing in Language Processing Method According to the Second Embodiment)

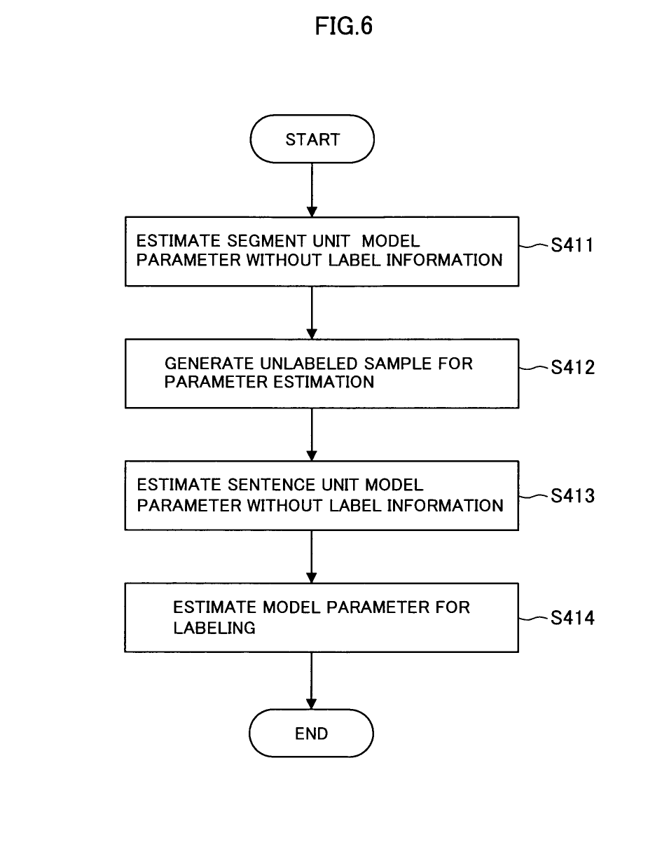

FIG. 6 is a flowchart showing a parameter estimation processing from learning a parameter required in analyzing the dependency structure based on a learning data to storing thereof in the language processing method in FIG. 4 according to this embodiment.

First, the segment unit model parameter without label information estimating part 232 calculates the segment unit model parameter without label information, i.e., {μᵢ} in the expression 6 by using the parsed corpus stored in the parsed corpus storage part 231, and sends to the segment unit model parameter without label information storage part 221 (step S411).

Next, the unlabeled sample for parameter estimation generating part 233 generates the unlabeled sample for parameter estimation for each sentence in the parsed corpus from the probability distribution Q(H|W) defined by the parameter, by using the parsed corpus stored in the parsed corpus storage part 231 and the unlabeled segment unit model parameter stored in the segment unit model parameter without label information storage part 221. Then there is sent to the sentence unit model parameter without label information estimating part 234 (step S412).

The sentence unit model parameter without label information estimating part 234 uses the parsed corpus stored in the parsed corpus storage part 231 and the unlabeled sample for parameter estimation generated by the unlabeled sample for parameter estimation generating part 233 to calculate the sentence unit model parameter without label information {λₖ}, and stores in the sentence unit model parameter without label information storage part 222 (step S413).

Then the model parameter for labeling estimating part 235 calculates the parameter of the model for labeling by using the parsed corpus stored in the parsed corpus storage part 231 and stores in the model parameter for labeling storage part 223 (step S414). Here, the parameter estimation processing ends.

(Advantage of the Second Embodiment)

According to the language processing method and the apparatus therefor in the second embodiment, in the dependency structure analysis method and the system that use Gibbs Sampling where any features in a sentence can be used, applying the maximum spanning tree searching method in searching the solution makes it possible to obtain a correct solution as the dependency structure tree. Further, after determining the destination of modification of each word, performing the determination of modification label as the post-processing makes it possible to identify the label of modification relation efficiently with small calculation amount.

### Third Embodiment

In the language processing method and the apparatus therefor in the third embodiment, the label estimation of the modification relation performed as the post-processing in the second embodiment is performed simultaneously with the determination of the destination of modification.

(Configuration of the Third Embodiment)

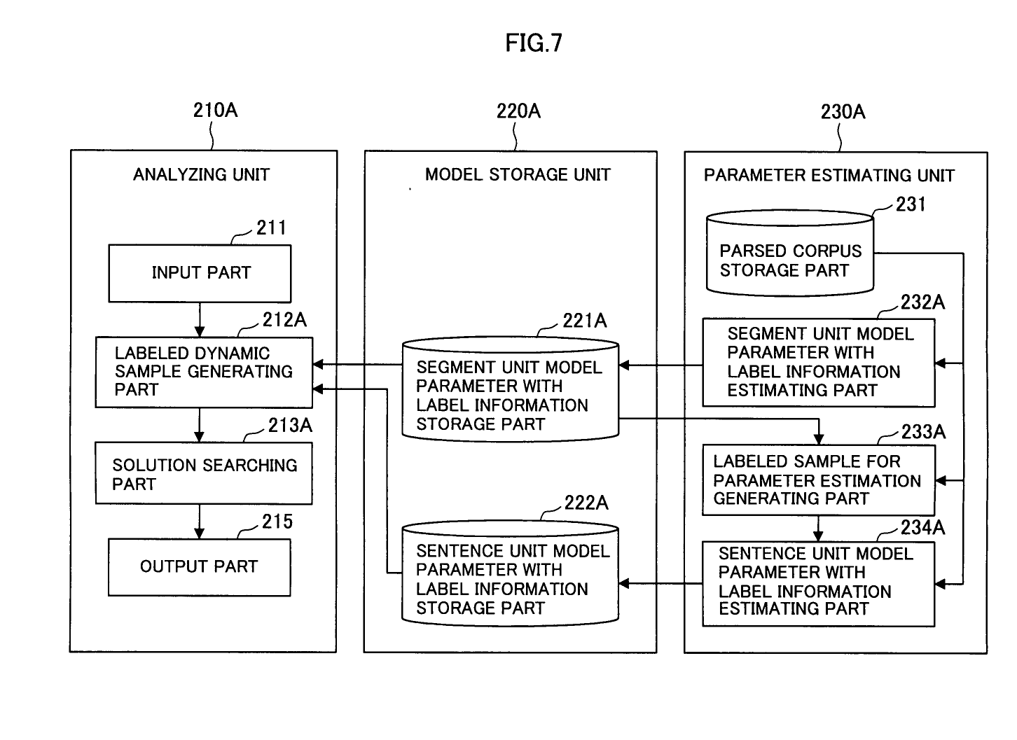

FIG. 7 is a configuration diagram schematically showing the language processing apparatus indicating this embodiment. The components common with those in FIG. 4 indicating the second embodiment have the common numerals attached.

The language processing apparatus in this embodiment does not have the modification relation label determining part 214 and the label information is dealt with by both the segment unit model and the sentence unit model. These are different from the configuration of the second embodiment. In other words, the language processing apparatus in this embodiment, which has the different configuration from that in the second embodiment, is configured by an analyzing unit 210A, a model storage unit 220A and a parameter estimating unit 230A.

The analyzing unit 210A includes: an input part 211 similar to the one in the second embodiment; a labeled dynamic sample generating part 212A having the different configuration from the one in the second embodiment; a solution searching part 213A connected to this sample generating part 212A and being the same as the one in the second embodiment; and an output part 215 connected to this solution searching part 213A and being the same as the one in the second embodiment. The model storage unit 220A, which has the different configuration from the one in the second embodiment, includes a first storage part (for example, a segment unit model parameter with label information storage part) 221A and a second storage part (for example, a sentence unit model parameter with label information storage part) 222A. Further, the parameter estimating unit 230A includes: a parsed corpus storage part 231 same as the one in the second embodiment; a segment unit model parameter with label information estimating part 232A having the different configuration from the one in the second embodiment; a labeled sample for parameter estimation generating part 233A having the different configuration from the one in the second embodiment; and a sentence unit model parameter with label information estimating part 234A having the different configuration from the one in the second embodiment. The corpus storage part 231, the parameter estimating parts 232A, 234A and the sample generating part 233A are connected to each other.

In the analyzing unit 210A, the labeled dynamic sample generating part 212A uses the information stored in the segment unit model parameter with label information storage part 221A and the sentence unit model parameter with label information storage part 222A with regard to the sentence input by the input part 211 to generate many samples of a labeled dependency structure analysis tree from the probability distribution defined by these model parameters. The solution searching part 213 connected to the output side of the labeled dynamic sample generating part 212A determines the labeled dependency structure of the input sentence by using the generated sample and outputs to the output part 215. Other configurations are the same as in the second embodiment.

(Language Processing Method According to the Third Embodiment)

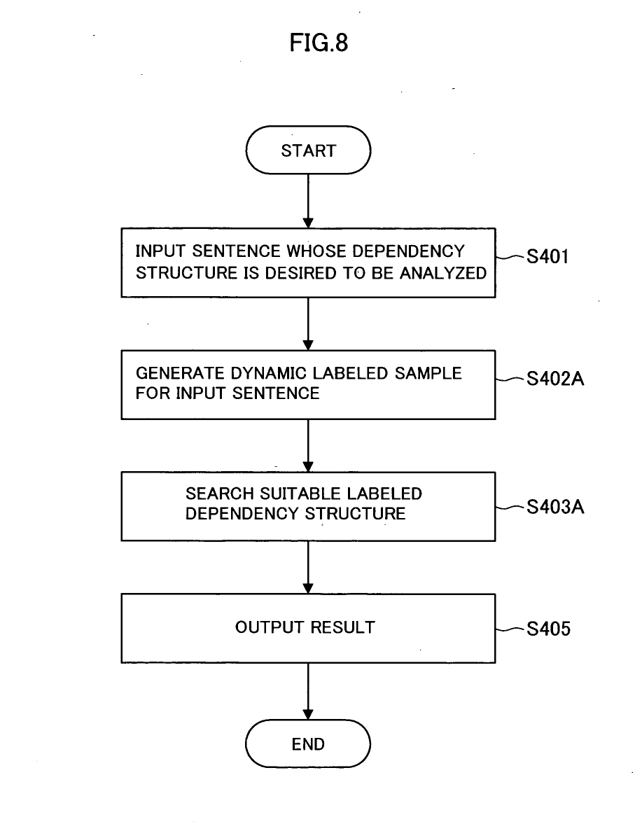

FIG. 8 is a flowchart showing a dependency structure analysis processing where the language processing apparatus shown in FIG. 7 analyzes the dependency structure of the sentence input by a user until the processing of outputting the sentence. The components common with those in FIG. 5 indicating the second embodiment have the common numerals attached.

In the dependency structure analysis processing according to this embodiment, the following processings are performed: the input processing of the sentence whose dependency structure is desired to be analyzed (step S401) similarly to the second embodiment; the generation processing of the dynamic labeled sample for the input sentence (step S402A) differently from the second embodiment; the searching processing of a suitable dependency structure (step S403) differently from the second embodiment; and the output processing of the result (step S405) similarly to the second embodiment.

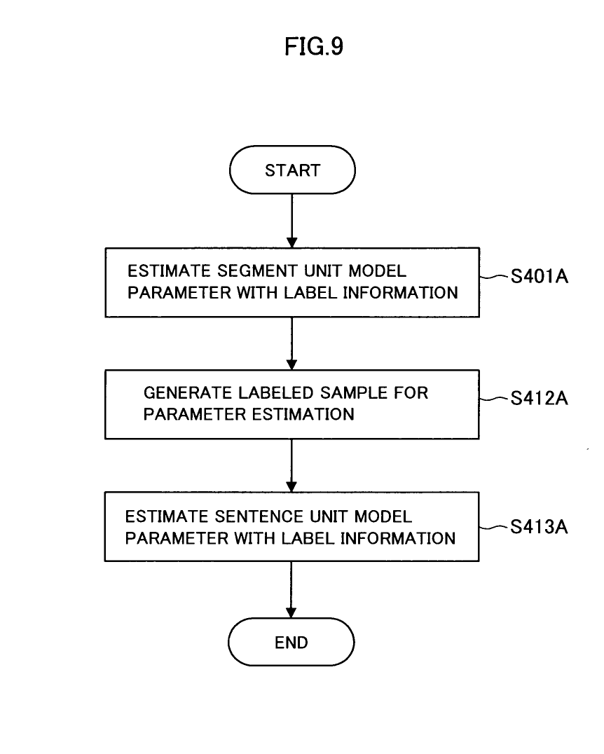

FIG. 9 is a flowchart showing a parameter estimation processing from learning a parameter required in analyzing the dependency structure based on a learning data to storing thereof in the language processing method in FIG. 7 according to the third embodiment and corresponds to FIG. 6 in the second embodiment.

In the parameter estimation processing according to this embodiment, the following processings are performed differently from the second embodiment: the processing of estimating the segment unit model parameter with label information (step S401A); the processing of generating the labeled sample for parameter estimation (step S412A); and the processing of estimating the sentence unit model parameter with label information (step S413A).

In the processings of FIGS. 8 and 9, since the segment unit model and the sentence unit model deal with the labeled information, which is different from the processing in the second embodiment, this point will be described hereinafter.

In the second embodiment, only the destination of modification is determined by using the probability models in units of segment and sentence which do not deal with the labeled information where only the destination of modification is considered as in the expressions 3-7. In this embodiment, on the other hand, the probability model as shown in the following expressions 29-33 considering the label of modification relation as well as the destination of modification is used, to determine both the destination of modification and the label.

$$\begin{matrix}P ( H , L \vert W ) = \frac{1}{Z ( W )} Q ( H , L \vert W ) exp \{ {\sum }_{k = 1}^{K} {λ}_{k} {f}_{k} ( W , H , L ) \} , & Expression 29 \\ Z ( W ) = {\sum }_{〈 {H}^{′} , {L}^{′} 〉 ∈ Ω ( W )}^{ } Q ( {H}^{′} , {L}^{′} \vert W ) exp \{ {\sum }_{k = 1}^{K} {λ}_{k} {f}_{k} ( W , {H}^{′} , {L}^{′} ) \} , & Expression 30 \\ Q ( H , L \vert W ) = {\prod }_{t = 1}^{\vert W \vert} q ( {h}_{t} , {l}_{t} \vert W , t ) , & Expression 31 \\ q ( h , l \vert W , t ) = \frac{1}{Y ( W , t )} exp \{ {\sum }_{i = 1}^{I} {μ}_{i} {g}_{i} ( W , t , h , l ) \} , & Expression 32 \\ Y ( W , t ) = {\sum }_{h , l}^{ } exp \{ {\sum }_{i = 1}^{ I} {μ}_{i} {g}_{i} ( W , t , h , l ) \} . & Expression 33\end{matrix}$$

In these expressions 29-33, Q(H, L|W) indicates the probability distribution of the labeled dependency structure in a unit of segment while λₖ indicates the sentence unit model parameter with label information. Ω(W) indicates the set configured by possible arbitrary combination of H and L in the case of giving W while fₖ(W, H, L) is an arbitrary feature in a unit of sentence. Further, μᵢ is the segment unit model parameter with label information. In addition, gᵢ(W, t, h, l) is the feature in a unit of segment about the fact that the t-th segment in a segment line W is dependent on the h-th segment with the relation of a label l. The sample generation and the parameter estimation in the case of using this model can be performed similarly to the cases of the second embodiment and the above proposal.

In FIG. 8, the labeled dynamic sample generating part 212A uses the segment unit model parameter with label information stored in the segment unit model parameter with label information storage part 221A and the sentence unit model parameter with label information stored in the sentence unit model parameter with label information storage part 222A to generate the sample of the labeled dependency structure tree dynamically by Gibbs Sampling for the segment line W input by the input part 211 (step S401) from the probability distribution of labeled dependency structure in a unit of sentence defined by these parameters (step S412).

Next, the solution searching part 213 searches and determines the solution that seems to be a suitable labeled dependency structure by using the S labeled samples {H⁽¹⁾, L⁽¹⁾, . . . , H^{(S)}, L^{(S)}} generated by the labeled dynamic sample generating part 212A (step S413). Here, the marginal probability defined as the following expressions 34-36 will be used.

$$\begin{matrix}{P}_{t} ( h , l \vert W ) = {\sum }_{{h}_{1} , {l}_{1} , … , {h}_{t - 1} , {l}_{t - 1} , {h}_{t + 1} , {l}_{t + 1} , … , {h}_{\vert W \vert} , {l}_{\vert W \vert} {h}_{t} = h , {l}_{t} = l}^{ } P ( H , L \vert W ) , & Expression 34 \\ ≅ \frac{1}{S} {\sum }_{s = 1}^{S} δ ( h , {h}_{t}^{( s )} ) δ ( l , {l}_{t}^{( s )} ) . & Expression 35\end{matrix}$$

Here, Pₜ(h, l|W) indicates the probability of h being the destination of modification of the t-th word and l being the label thereof. Then the word of the destination of modification is indicated as h, the word of the source of modification is indicated as d and the label of modification relation is indicated as l, to define the score s(h, d, l) by using the marginal probability.

s(h,d,l)=log P_{d}(h,l|W). Expression 36

Using such a score s(h, d, l) makes it possible to search the maximum spanning tree and calculate the suitable solution, similarly to the second embodiment.

(Advantage of the Third Embodiment)

According to this embodiment, although the calculation amount is larger than in the second embodiment, performing the determination of the destination of modification and the identification of the label of the modification relation at the same time makes it possible to analyze the dependency structure with high accuracy by using the feature with these pieces of information integrated. In other words, it becomes possible to deal with the segment of the destination of modification and the label information integrally and to analyze the dependency structure with high accuracy.

### Fourth Embodiment

In the language processing method and the apparatus therefor in this embodiment, the second embodiment and 2 are combined and the estimation of the label information performed in the segment unit model in the third embodiment is performed as a separate processing by using the model for labeling separately prepared.

(Configuration of the Fourth Embodiment)

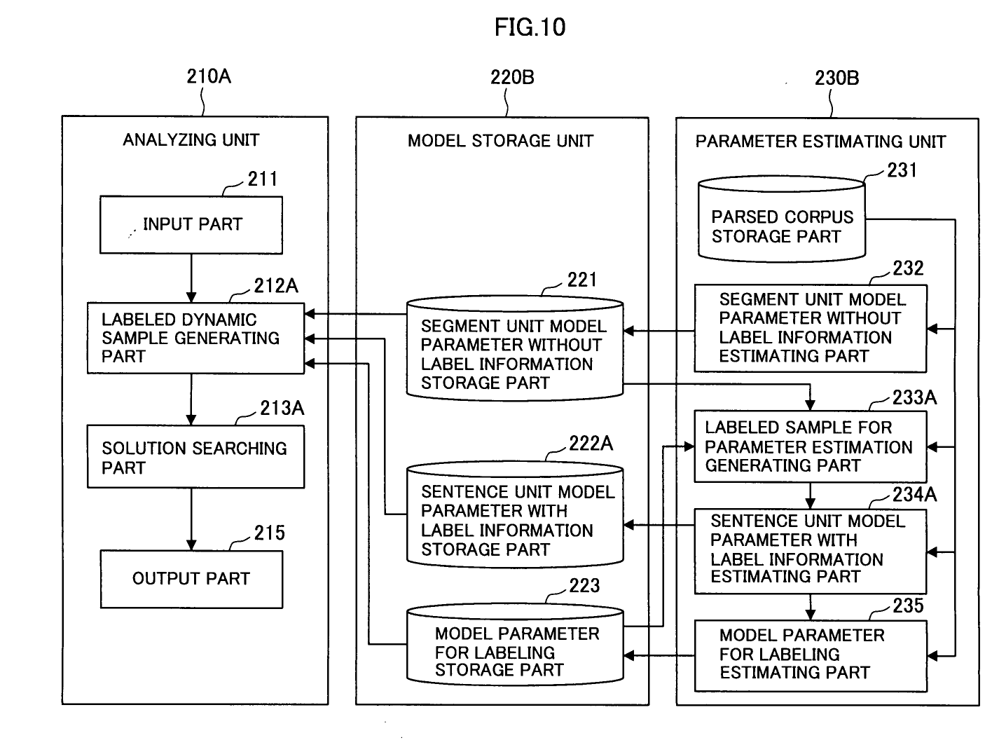

FIG. 10 is a configuration diagram schematically showing the language processing apparatus indicating the fourth embodiment of the present invention. The components common with those in FIGS. 4 and 7 indicating the second and third embodiments have the common numerals attached.

The language processing apparatus in this embodiment does not deal with the label information in the segment unit model and deals with the label information by using the model for labeling separately prepared. These are different from the configuration of the third embodiment. In other words, the language processing apparatus in this embodiment is configured by an analyzing unit 210A same as the one in the third embodiment, a model storage unit 220B and a parameter estimating unit 230B that have different configuration from those in the third embodiment.

The model storage unit 220B includes a first storage part (for example, a segment unit model parameter without label information storage part) 221, a third storage part similarly to that in the third embodiment (for example, sentence unit model parameter with label information storage part) 222A and a second storage part similarly to the one in the second embodiment (for example, a model parameter for labeling storage part) 223. Further, the parameter estimating unit 230B includes: a parsed corpus storage part 231 same as the one in the second embodiment; a segment unit model parameter without label information estimating part 232 same as the one in the second embodiment; a labeled sample for parameter estimation generating part 233A similarly to the one in the third embodiment; a sentence unit model parameter with label information estimating part 234A similarly to the one in the third embodiment; and a model parameter for labeling estimating part 235 similarly to the one in the second embodiment. The corpus storage part 231, the parameter estimating parts 232, 234A, 235 and the sample generating part 233A are connected to each other.

In the analyzing unit 210A, the labeled dynamic sample generating part 212A uses the model parameter information stored in the segment unit model parameter without label information storage part 221, the sentence unit model parameter with label information storage part 222A and the model parameter for labeling storage part 223 with regard to the sentence input by the input part 211 to generate many samples of a labeled dependency structure analysis tree from the probability distribution defined by these model parameters.

In the parameter estimating unit 230B, the labeled sample for parameter estimation generating part 233A generates the labeled sample of dependency structure for each sentence in the corpus from the probability distribution defined by the parameter, by using the corpus stored in the parsed corpus storage part 231, the segment unit model parameter without label information stored in the segment unit model parameter without label information storage part 221 and the model parameter for labeling stored in the model parameter for labeling storage part 223. Then the labeled sample for parameter estimation generating part 233A sends the generated sample to the sentence unit model parameter with label information estimating part 234A. In addition, the model parameter for labeling estimating part 235 calculates the parameter of model for labeling by using the corpus stored in the parsed corpus storage part 231 and stores the result in the model parameter for labeling storage part 223. Other configurations are almost the same as those in the second and third embodiments.

(Language Processing Method According to the Fourth Embodiment)

The contents of a flowchart showing a dependency structure analysis processing from analyzing the dependency structure of the sentence input by a user until outputting the sentence in the language processing method in this embodiment are the same as those in FIG. 8 indicating the third embodiment.

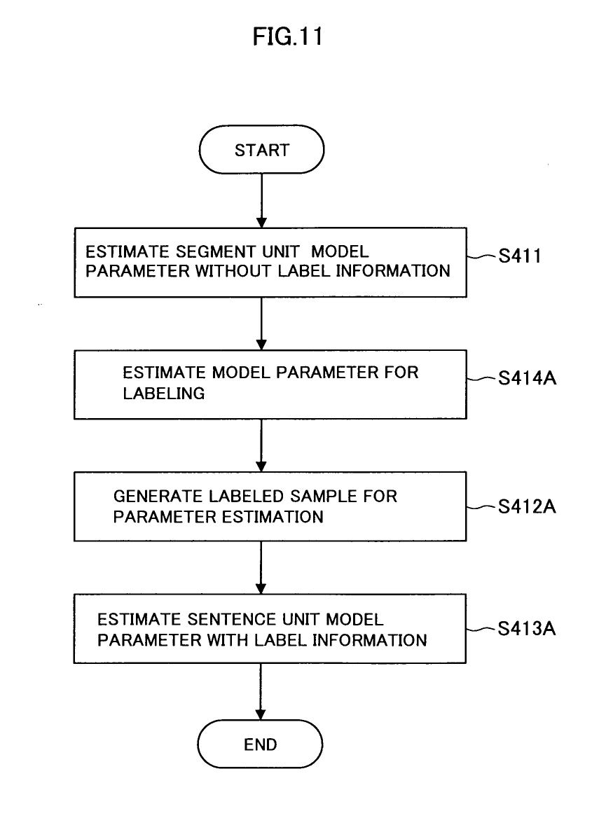

FIG. 11 is a flowchart showing a parameter estimation processing from learning a parameter required in analyzing the dependency structure based on a learning data to storing thereof in the language processing method in FIG. 10 according to the fourth embodiment and corresponds to FIG. 6 in the second embodiment and FIG. 9 in the third embodiment.

In the parameter estimation processing according to this embodiment, the following processings are performed: the processing of estimating the segment unit model parameter without label information (step S411) similarly to the second embodiment; the processing of estimating model parameter for labeling (step S414A) differently from the second embodiment; the processing of generating the labeled sample for parameter estimation (step S412A) similarly to the third embodiment; and the processing of estimating the sentence unit model parameter with label information (step S413A) similarly to the third embodiment.

In the processing of FIG. 11, since the label information is not dealt with in the segment unit model and is dealt with by using the model for labeling separately prepared, which is different from the processing in the third embodiment, this point will be described hereinafter.

In the third embodiment, the segment unit model considering the label of modification relation as well as the destination of modification as indicated by the expressions 31 and 33 has been used. Since such a model can deal with the information on the destination of modification and the label in an integrated manner, it can be expected that the analysis can be performed with high accuracy. However, on the other hand, since the combination of the destination of modification and the label must be considered, the calculation amount is to increase.

Therefore in this embodiment, the destination of modification and the label are considered at the same time as in the third embodiment with regard to the model in a unit of sentence while only the destination of modification is considered as in the second embodiment with regard to the model in a unit of segment, to define the probability model as the following expressions 37-39.

$$\begin{matrix}P ( H , L \vert W ) = \frac{1}{Z ( W )} {Q}^{′} ( H , L \vert W ) exp \{ {\sum }_{k = 1}^{K} {λ}_{k} {f}_{k} ( W , H , L ) \} , & Expression 37 \\ Z ( W ) = {\sum }_{〈 {H}^{′} , {L}^{′} 〉 ∈ Ω ( W )}^{ } {Q}^{′} ( {H}^{′} , {L}^{′} \vert W ) exp \{ {\sum }_{k = 1}^{K} {λ}_{k} {f}_{k} ( W , {H}^{′} , {L}^{′} ) \} , & Expression 38 \\ {Q}^{′} ( H , L \vert W ) = Q ( H \vert W ) P ( L \vert W , H ) . & Expression 39\end{matrix}$$

In these expressions 37-39, Q(H|W) indicates the probability distribution of the unlabeled dependency structure in a unit of segment defined by the expression 5, P(L|W, H) indicates the model for labeling defined by the expression 26, λₖ indicates the sentence unit model parameter with label information, Ω(W) indicates the set configured by possible arbitrary combination of H and L in the case of giving W and fₖ(W, H, L) is an arbitrary feature in a unit of sentence. The sample generation and the parameter estimation in the case of using this model can be performed similarly to the cases of the first and second embodiments.

In the analyzing unit 210A, the labeled dynamic sample generating part 212A uses the segment unit model parameter without label information stored in the segment unit model parameter without label information storage part 221, the sentence unit model parameter with label information stored in the sentence unit model parameter with label information storage part 222A and the model parameter for labeling stored in the model parameter for labeling storage part 223 with regard to the segment line W input by the input part 211 to generate a sample of labeled dependency structure tree dynamically by Gibbs Sampling from the probability distribution defined by these parameters. The similar processing to that in the third embodiment is performed in the solution searching part 213 and the output part 215, based on the generation result.

(Advantage of the Fourth Embodiment)

According to this embodiment, although the calculation amount is small as it is not necessary to consider the label information in the segment unit model, the dependency structure analysis can be performed with high accuracy as the label information is considered in the model in a unit of sentence. In other words, the segment unit model only determines the destination of modification and the identification of the label is dealt with in another model, while the sentence unit model determines the destination of modification and identifies the label at the same time. Thereby the dependency structure analysis can be performed with high accuracy while reducing the calculation amount.

Although the preferred embodiment of the present invention has been described referring to the accompanying drawings, the present invention is not restricted to such examples. It is evident to those skilled in the art that the present invention may be modified or changed within a technical philosophy thereof and it is understood that naturally these belong to the technical philosophy of the present invention.

In the above embodiment, although there has been described by giving an example of considering only which word each word in the input sentence depends on as the result of analyzing the dependency structure, the present invention is not restricted to such an example. For example, as well as considering which word is the destination of modification, there may be dealt with the label information on the relation to the word at the destination of modification.

In the above embodiment, in addition, although there has been described by giving an example of processing of the language processing apparatus 101 on Japanese, the language processing apparatus 101 is applicable without depending on language and therefore is not restricted to such an example. For example, the language processing apparatus 101 can process on the document in various languages such as English or the document mixed with Japanese, English and so on.

In the above embodiment, further, although there has been described by giving an example of using the feature in a unit of sentence as a set of segments as well as the feature in a unit of segment on the language processing apparatus 101's side, the present invention is not restricted to such an example. For example, there can be expanded so that the language processing apparatus 101 can use the feature in a unit of document as a set of sentences as well as the feature in a unit of segment.

In the above embodiment, although there has been described by giving an example of using Gibbs Sampling, the present invention is not restricted to such an example. For example, the suitable dependency structure can be obtained by using “annealing method” described in the reference literature 1 and other methods. The annealing method is an optimization algorithm capable of being used in conjunction with Gibbs Sampling.

What is claimed is:

1. A language processing apparatus that analyzes a dependency structure of an input sentence, comprising:
a segment unit model parameter estimating part that estimates a segment unit model parameter as a parameter of a probability model to analyze the dependency structure by using a feature in a unit of segment;
a sentence unit model parameter estimating part that estimates a sentence unit model parameter as a parameter of a probability model to analyze the dependency structure by using a feature in a unit of sentence;
a sample generating part that generates a sample of the dependency structure of the input sentence from the probability model defined by the sentence unit model parameter and the segment unit model parameter; and
a dependency structure determining part that determines a suitable dependency structure from the sample of the dependency structure of the input sentence generated by the sample generating part.

2. The language processing apparatus according to claim 1, wherein the dependency structure determining part determines a destination of modification of each segment in the input sentence by maximizing a marginal probability approximately calculated based on the sample of the dependency structure of the input sentence generated by the sample generating part.

3. The language processing apparatus according to claim 2, wherein the dependency structure determining part determines the destination of modification of each segment in the input sentence in accordance with constraints where the probability of an arbitrary segment in the input sentence depending on a previous segment is 0, where the probability of a last segment in the input sentence becoming a head-word of the whole input sentence is 1 and where the probability of a next-to-last segment in the input sentence depending on the last segment is 1.

4. A language processing method that analyzes a dependency structure of an input sentence, comprising:
a segment unit model parameter estimating step that estimates a segment unit model parameter as a parameter of a probability model to analyze the dependency structure by using a feature in a unit of segment;
a sentence unit model parameter estimating step that estimates a sentence unit model parameter as a parameter of a probability model to analyze the dependency structure by using a feature in a unit of sentence;
a sample generating step that generates a sample of the dependency structure of the input sentence from the probability model defined by the sentence unit model parameter and the segment unit model parameter; and
a dependency structure determining step that determines a suitable dependency structure from the sample of the dependency structure of the input sentence generated by the sample generating step.

5. A computer program that makes a computer function as a language processing apparatus that analyzes a dependency structure of an input sentence, comprising:
a segment unit model parameter estimating module that estimates a segment unit model parameter as a parameter of a probability model to analyze the dependency structure by using a feature in a unit of segment;
a sentence unit model parameter estimating module that estimates a sentence unit model parameter as a parameter of a probability model to analyze the dependency structure by using a feature in a unit of sentence;
a sample generating module that generates a sample of the dependency structure of the input sentence from the probability model defined by the sentence unit model parameter and the segment unit model parameter; and
a dependency structure determining module that determines a suitable dependency structure from the sample of the dependency structure of the input sentence generated by the sample generating module.

6. A language processing method wherein the sample of the dependency structure of the input sentence is generated from the probability model defined by the segment unit model parameter and the sentence unit model parameter and the suitable dependency structure is determined from the generated sample by using a maximum spanning tree searching method.

7. The language processing method according to claim 6, wherein when the determined dependency structure is an unlabeled dependency structure, a label of modification relation for the unlabeled dependency structure is identified by using the probability model defined by a model parameter for labeling.

8. A language processing method wherein the label of the modification relation as well as a destination of modification of each word in the input sentence are simultaneously processed by a segment unit model and a sentence unit model by generating a sample of labeled dependency structure tree of the input sentence by using a segment unit model parameter with label information and a sentence unit model parameter with label information.

9. A language processing method wherein the label of the modification relation and the destination of modification are simultaneously processed in the sentence unit model in the input sentence while the destination of modification and the label are separately processed in the segment unit model in the input sentence by generating the sample of the labeled dependency structure tree of the input sentence by using a segment unit model parameter without label information, the model parameter for labeling and the sentence unit model parameter with label information.

10. A language processing apparatus comprising:
a dynamic sample generating part that generates the sample of the dependency structure of the input sentence from the probability model defined by the segment unit model parameter and the sentence unit model parameter; and
a solution searching part that determines the suitable dependency structure from the generated sample by using a maximum spanning tree searching method.

11. The language processing apparatus according to claim 10, wherein the language processing apparatus further comprises:
a first storage part that stores the segment unit model parameter; and
a second storage part that stores the sentence unit model parameter.

12. The language processing apparatus according to claim 10, wherein the language processing apparatus further comprises a modification relation label determining part that identifies a label of modification relation for the unlabeled dependency structure by using the probability model defined by a model parameter for labeling when the determined dependency structure is an unlabeled dependency structure.

13. The language processing apparatus according to claim 12, wherein the language processing apparatus further comprises a third storage part that stores the model parameter for labeling.

14. A language processing apparatus comprising:
a labeled dynamic sample generating part that processes the label of the modification relation as well as a destination of modification of each word in the input sentence simultaneously by a segment unit model and a sentence unit model by generating a sample of labeled dependency structure tree of the input sentence by using a segment unit model parameter with label information and a sentence unit model parameter with label information; and
a solution searching part that determines the suitable dependency structure from the generated sample by using a maximum spanning tree searching method.

15. The language processing apparatus according to claim 14, wherein the language processing apparatus further comprises:
a first storage part that stores the segment unit model parameter with label information; and
a second storage part that stores the sentence unit model parameter with label information.

16. A language processing apparatus comprising:
a labeled dynamic sample generating part that processes the label of the modification relation and the destination of modification simultaneously in the sentence unit model in the input sentence and processes the destination of modification and the label separately in the segment unit model in the input sentence by generating the sample of the labeled dependency structure tree of the input sentence by using a segment unit model parameter without label information, the model parameter for labeling and the sentence unit model parameter with label information; and
a solution searching part that determines the suitable dependency structure from the generated sample by using a maximum spanning tree searching method.

17. The language processing apparatus according to claim 16, wherein the language processing apparatus further comprises:
a first storage part that stores the segment unit model parameter without label information;
a second storage part that stores the model parameter for labeling; and
a third storage part that stores the sentence unit model parameter with label information.
